(19) United States
(12) Patent Application Publication
(10) Pub. No.: US 2026/0177661 A1
(43) Pub. Date: Jun. 25, 2026

(54) Method for observing an environment with an ambiguity removal mode and a listening mode and associated devices

(71) Applicant: THALES, Meudon (FR)

(72) Inventors: Philippe GOY, MERIGNAC (FR); Thierry MAZEAU, MERIGNAC (FR); Rodolphe COTTRON, MERIGNAC (FR)

(21) Appl. No.: 19/417,440

(22) Filed: Dec. 12, 2025

(30) Foreign Application Priority Data
Dec. 24, 2024 (FR) 2415253

(51) Int. Cl. G01S 7/292; G01S 13/58

(52) U.S. Cl. CPC G01S 7/2923; G01S 13/582

(57) ABSTRACT

A method for observing an environment includes the implementation of several recurrences of a signal emission and reception step, at least one sequence of recurrences including, for N and M two integers: N first recurrences comprising the emission of pulses in a first direction at a first frequency and the reception of echoes emitted following this emission; M recurrences comprising the emission of pulses in a second direction at a second frequency; and N second recurrences comprising the emission of pulses at a repetition period in the second direction at the second frequency, and the reception of echoes emitted following this emission.

This patent application claims the benefit of document FR 24/15253 filed on Dec. 24, 2024 which is hereby incorporated by reference

The present invention relates to a method for observing an environment using a radar. It also relates to devices adapted for implementing such a method, namely a radar, an observation system, and an aircraft.

The modes to remove distance ambiguity, notably Doppler, include the emission and reception of a number of recurrences comprising a “dead time” and a “useful time” of analysis.

The dead time corresponds to the propagation time of echoes corresponding to the maximum instrumented distance desired for the application, so that all received echoes can be processed coherently over all analysis recurrences.

There is therefore a need for a method allowing the exploitation or removal of said dead time recurrences without degrading detection performance.

To this end, the description aims at a method for observing an environment, the method being implemented by an observation system including a radar and comprising the implementation of several recurrences of a signal emission and reception step, the method comprising at least one sequence of recurrences comprising, for N and M two integers:
N first recurrences comprising a step of:
   emitting pulses at a repetition period in a first direction at a first frequency, and
   receiving the echoes emitted at the first frequency in the first direction,
M recurrences following the N first recurrences and comprising a step of:
   emitting pulses at the repetition period in a second direction at a second frequency, the second direction being different from the first direction and the second frequency being different from the first frequency, and
   listening to the echoes emitted at the first frequency in the first direction, and
N second recurrences following the M recurrences and comprising a step of:
   emitting pulses at the repetition period in the second direction at the second frequency, and
   receiving the echoes emitted at the second frequency in the second direction.

According to other advantageous aspects of the invention, the surveillance method comprises one or more of the following features, taken individually or in any technically possible combination:
the method comprises the implementation of P sequences, each sequence being implemented at a respective repetition period.
each sequence includes an additional series of:
   M additional recurrences following N recurrences and comprising a step of:
      emitting pulses at the repetition period in an additional direction at an additional frequency, the additional direction being different from the directions of the previous recurrences and the additional frequency being different from the frequencies of the previous recurrences, and
      listening to the echoes emitted at the frequency and direction of the echoes received during the reception step of the N recurrences that the M additional recurrences follow, and
   N additional recurrences following the M additional recurrences and comprising a step of:
      emitting pulses at the repetition period in the additional direction at the additional frequency, and
      receiving the echoes emitted at the additional frequency in the additional direction,
         the sequence including additional series for K directions observed by the radar, K being an integer greater than or equal to 3.
during each emission step, at least one emitted pulse includes a respective random phase introduced by the radar and each reception step of an echo received from the at least one emitted pulse with a random phase comprises the compensation of the phase shift related to the introduced random phase.
the method includes a step of processing the received echoes to determine at least one of a distance of a target and a speed of a target in the environment.
the method includes a step of analyzing the echoes listened to during a listening to obtain an electromagnetic behavior in the direction and frequency of the listened echoes.
the processing step takes into account the electromagnetic behavior obtained in the analysis step.

The description also aims at a radar adapted to implement several recurrences of a signal emission and reception step, at least one sequence of recurrences comprising, for N and M two integers:
N first recurrences during which the radar is adapted to:
   emit pulses at a repetition period in a first direction at a first frequency, and
   receive echoes emitted at the first frequency in the first direction,
M recurrences following the N first recurrences and during which the radar is adapted to:
   emit pulses at the repetition period in a second direction at a second frequency, the second direction being different from the first direction and the second frequency being different from the first frequency, and
   listen to echoes emitted at the first frequency in the first direction, and
N second recurrences following the M recurrences and during which the radar is adapted to:
   emit pulses at a repetition period in the second direction at the second frequency, and
   receive echoes emitted at the second frequency in the second direction.

The description also relates to an observation system including a radar as previously described.

The description also aims at an aircraft comprising a radar as previously described, or an observation system as previously described.

In the present description, the expression “adapted to” means interchangeably “adapted for” or “configured for”.

The invention will become clearer upon reading the following description, given solely by way of non-limiting example, and made with reference to the drawings wherein:

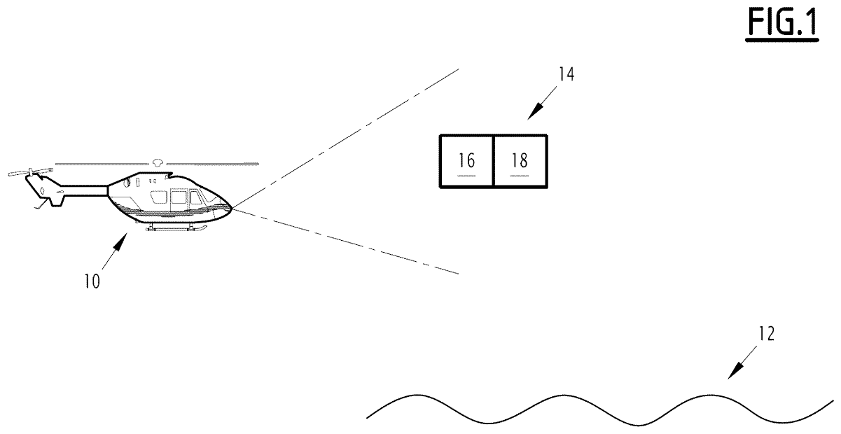

FIG. 1 is a schematic representation of an aircraft featuring an environment observation system,

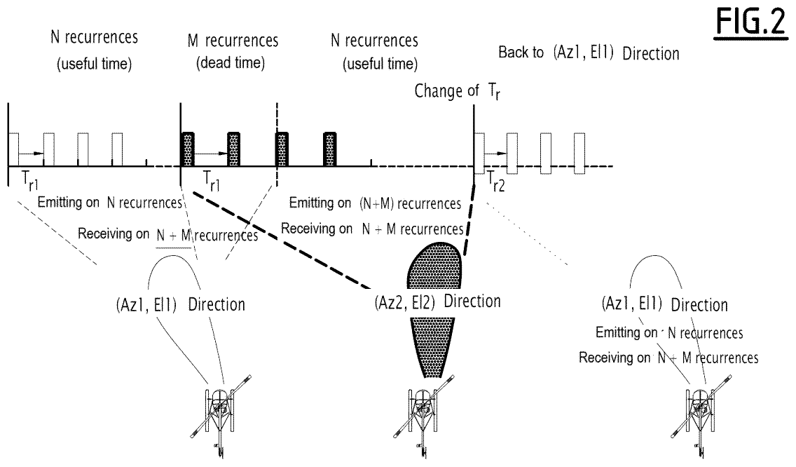

FIG. 2 is a schematic illustration of an example of implementing an observation method by the observation system, and

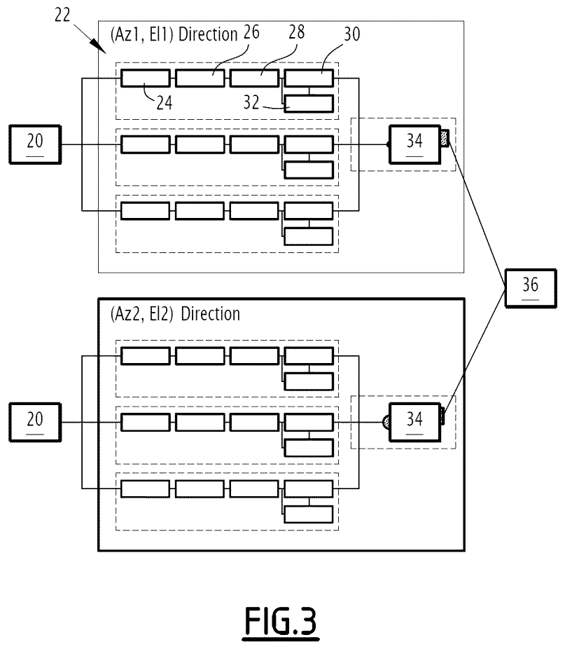

FIG. 3 is a representation of a radar signal processing flowchart visible in FIG. 2.

An aircraft 10 is schematically represented in FIG. 1.

The aircraft 10 is used here to observe the environment 12.

The aircraft 10 seeks, in particular, to detect the presence of potential targets.

The aircraft 10 is equipped with an observation system 14, the observation system 14 including a radar 16 interacting with a computer 18.

The radar 16 enables, for example, the detection of the position and/or speed of targets by observing the environment in Doppler mode.

More generally, the radar is adapted to implement any detection mode with ambiguity removal.

For this, as explained later, the radar 16 implements several recurrences of a signal emission and reception step.

Here “recurrence” should be understood to mean a time interval comprising a part dedicated to emission and a part dedicated to reception. This does not imply that the radar 16 actually emits radar pulses or receives echoes.

The computer 18 is, for example, made in the form of a programmable circuit of the FPGA type (“Field Programmable Gate Array”) and/or of the ASIC type (“Application-Specific Integrated Circuit”). In addition or alternatively, the computer 18 is made at least partially in the form of software executable by a processor and stored in a memory.

The specific operation of the radar 16 is now illustrated with reference to FIG. 2, which shows an example of implementing an observation method of the environment 12 that the observation system 14 is adapted to implement.

This case corresponds to a simple example of implementation allowing a good understanding of the principle of operation of the radar 16, the generation of this method to any case being detailed later.

As visible in this FIG. 2, a sequence of recurrences of a radar 16 is schematically represented.

This sequence successively comprises N first recurrences, M recurrences, and N second recurrences.

N and M are integers, generally greater than or equal to 2, typically greater than or equal to 4.

The N first recurrences comprise a step of emitting pulses at a repetition period T_{R1} in a first direction D1 at a first frequency Fe1.

The first direction D1 corresponds to a first direction identified in azimuth and elevation by the pair (Az1, El1).

The N first recurrences also include the reception of echoes from the environment 12 emitted at the first frequency Fe1 in the first direction D1 in response to the emitted pulses.

From the Doppler mode point of view, the reception performed during the N first recurrences corresponds to a useful time.

The M recurrences following the N first recurrences include a step of emitting pulses at the repetition period T_{R1} in a second direction D2 at a second frequency Fe2.

The second direction D2 being different from the first direction D1.

The second direction D2 corresponds to a second direction identified in azimuth and elevation by the pair (Az2, El2).

In the case of scanning neighboring directions, one of the coordinates Az2 or El2 of the second direction D2 is identical to one of the coordinates Az1 or El1 of the first direction D1, but it is quite possible to apply the sequence to two non-contiguous directions D1 and D2.

The second frequency Fe2 is also different from the first frequency Fe1.

The M recurrences do not receive echoes of the pulses emitted in the second direction D2 due to the propagation time required for the pulses to reach the target and return to the radar 16.

In this sense, for the Doppler mode with distance ambiguity removal, the M recurrences correspond to a dead time for reception.

The M “dead time” recurrences correspond to the round-trip time of echoes at the maximum instrumented distance.

The number M of such recurrences can be obtained by applying the following formula:

$$M = ceil \{ \frac{2 {D}_{max}}{{cT}_{R}} \}$$

Where:
ceil denotes the upper integer,
Dₘₐₓ is the maximum instrumented distance,
c denotes the speed of light, and
T_{R} denotes the repetition period.

As an order of magnitude, for a maximum instrumented distance of Dₘₐₓ=150 km, a repetition period T_{R} corresponding to an average repetition frequency of 10 kHz, this leads to a value of M=10.

In this example, this leads to a time interval of 1 ms.

This dead time corresponds to an eclipse duration or a latency period.

This dead time is sometimes referred to by the English term “fill pulses,” which refers to the number of additional pulses required to ensure consistent and identical processing across each level of ambiguity.

According to the invention, the M recurrences are used to implement a listening to the echoes emitted at the first frequency Fe1 in the first direction D1.

Thus, a dead time for the Doppler mode is used to obtain additional information about the environment 12.

The N second recurrences include the emission of pulses at the repetition period T_{R1} in the second direction D2 at the second frequency Fe2.

The N second recurrences also comprise the reception of echoes from the environment 12 emitted at the second frequency Fe2 in the second direction D2 in response to the emitted pulses.

Compared to the M recurrences where no emitted pulse is returned as an echo, the N second recurrences can be seen as N analysis recurrences.

The distinction between the different echoes is made using a phase code.

The distinction of echoes related to different distance ambiguity ranks on the first direction D1 is made using a phase code. The phase code allows as many power maps associated with a distance ambiguity rank to be obtained, isolated from others.

The second direction D2 is nominally processed by the computer 18 with a power map and a detection on all folded ambiguity ranks on the same map if no phase code is used (first case) or identically (second case).

More precisely, during each emission step, an emitted pulse includes a respective random phase introduced by the radar and, during each reception step, an echo received from the at least one emitted pulse with a random phase comprises the compensation of the phase shift related to the introduced random phase.

This pulse is the pulse for which the overlap is implemented, in this case the first pulse.

In the sequence just illustrated, an overlap is performed between emissions/receptions to overcome part of the dead time of the Doppler mode (the one that occurs at the level of the M recurrences).

This allows listening time to be gained on a dead time of the Doppler mode.

To perform a Doppler mode, the sequence is repeated several times at a respective repetition period as schematically illustrated on the right side of FIG. 2 with a change in the repetition period value at the end of the sequence (transition from a first repetition period T_{R1} to a second repetition period T_{R2}).

More precisely, P sequences are implemented.

The number P is chosen to allow ambiguity removal.

An ambiguity removal is a detection extractor that performs a “K/N” test to confirm a detection on N detection maps obtained on N values of repetition periods Tr.

Typically, K/N values for ambiguity removal are found, such as 2/2, ⅔ or 2/4, ⅗, ⅜ or even ⅝.

In the simple example described, P is assumed to be equal to 2.

In other words, the previous sequence is repeated between the two directions D1 and D2 until the repetition period barrel is emptied to proceed with ambiguity removal (distance, speed) by recombining the repetition periods.

When each echo of a set of P sequences is obtained, it is possible to implement a processing of the received echoes to determine at least one of a distance of a target and a speed of a target in the environment 12 according to the desired Doppler mode.

This processing by the computer 18 is a parallel processing for each ambiguity rank as schematically illustrated by FIG. 3.

The processing first includes an operation including a phase compensation and a duplication of signals (rectangle 20 in FIG. 3) to obtain as many signals as ambiguity ranks (i.e., M+1 and thus 3 for M=2).

This operation is performed for each direction, so that two rectangles 20 are visible in FIG. 3.

It can be noted that for the first direction D1, a shift of recurrences to be processed exists (the recurrences among M are progressively integrated) while, for the second direction D2, either the phase code is used by proceeding similarly to the first direction D1 or a single detection map is used leaving the resolution of ambiguities to the extractor.

Each ambiguity rank is also subject to processing implemented by a path 22, so that there are here 3*2=6 paths 22.

The same processing is applied to each path 22 and comprises usual operations, such as a pulse compression operation (rectangle 24), a clutter rejection operation (rectangle 26), a Doppler processing operation (rectangle 28), a TFAC detection operation (rectangle 30), and an ambient noise measurement operation (rectangle 32).

At the output of each path 22, a single extraction block 34 makes it possible to combine the different ambiguity ranks to obtain the sought speed and/or distance of the target.

Alternatively, each path 22 includes an extraction block 34 performing an extraction of the speed and/or distance.

In each case, the extraction block(s) 34 are connected to a tracking block.

In the example shown in FIG. 3, the tracking block 36 makes it possible to combine the information thus obtained for the purpose of tracking a target, i.e., the tracking block 36 provides plots for a tracking system (not shown).

The described method allows certain dead times to be removed, in this case for the first direction D1.

Other uses of listening are nevertheless possible.

A non-limiting example is now described.

The ambient noise measurement operation (rectangle 32) is advantageously performed using the listening step.

For this, the method also includes analyzing the echoes listened to during a listening to obtain an electromagnetic behavior in the direction and frequency of the listened echoes.

Thus, the listening performed during the M recurrences makes it possible to obtain an ambient map in the first direction D1 at the first frequency Fe1.

In other words, the processing step takes into account the electromagnetic behavior obtained in the analysis step.

This allows a faster implementation of the method as it is not necessary to dedicate specific time to listening in addition to the recurrences used for implementing the Doppler mode.

It could also be considered to listen in the second direction D2 during the M recurrences.

This could make it possible to react if the direction-frequency pair corresponds to a polluted frequency, notably by changing the pair thanks to the listening performed.

The described method is also compatible with the observation of more than two directions.

It is therefore a matter of observing K directions where K is an integer greater than or equal to 3.

For each additional observed direction (in addition to the two previous directions), each sequence includes an additional series of recurrences comprising M additional recurrences following N recurrences and N additional recurrences following the M additional recurrences.

The M additional recurrences comprise a step of emitting pulses at the repetition period in an additional direction at an additional frequency, the additional direction being different from the directions of the previous recurrences and the additional frequency being different from the frequencies of the previous recurrences.

For K=3, this means that the M additional recurrences comprise a step of emitting pulses at the current repetition period in a third direction D3 at a third frequency Fe3, that the third direction D3 is different from the first and second directions D1 and D2, and that the third frequency Fe3 is different from the first and second frequencies Fe1 and Fe2.

The M additional recurrences also include a step of listening to the echoes emitted at the frequency and direction of the echoes received during the reception step of the N recurrences that the M additional recurrences follow.

For the described example, this means that the M additional recurrences comprise listening to the echoes at the second frequency Fe2 and in the second direction D2.

The N additional recurrences comprise a step of emitting pulses at the repetition period in the additional direction at the additional frequency.

For the example at K=3, this means that the radar 16 emits pulses at the current repetition period in the third direction D3 at the third frequency Fe3.

The N additional recurrences also include a step of receiving the echoes emitted at the additional frequency in the additional direction.

Still for the described example, this corresponds to the reception by the radar of echoes emitted by the environment 12 in the third direction D3 at the third frequency Fe3.

For this sequence, 2 listening times corresponding to 2 dead times of the Doppler mode are thus gained.

More generally, a listening time is gained for each additional series, so that for K observed directions, (K−1) listening times corresponding to (K−1) dead times of the Doppler mode are gained. Indeed, there is a dead time phase that cannot be gained at each repetition period change.

In theory, a different and discernible phase code must be used for each direction. However, in practice, two different codes suffice as the echoes from the third direction D3 will not be captured during reception on the first direction D1.

The implementation of the method for K directions also involves adding additional paths 22. In the general case, the processing involves using K*M different paths (if the last direction is treated like the others with phase codes).

This is nevertheless not a problem as they are identical paths.

It can also be indicated here that the method is applicable to fixed or mechanically scanned radar architectures equipped with active antennas in one or two planes, as long as conventional beamforming has enough available paths to digitize for the application.

Active antenna radars are often referred to by the abbreviation AESA, which refers to the corresponding term “Active Electronically Scanned Array”.

1. A method for observing an environment, the method being implemented by an observation system including a radar and comprising the implementation of several recurrences of a signal emission and reception step, the method comprising at least one sequence of recurrences comprising, for N and M two integers:
N first recurrences comprising a step of:
emitting pulses at a repetition period in a first direction at a first frequency, and
receiving the echoes emitted at the first frequency in the first direction,
M recurrences following the N first recurrences and comprising a step of:
emitting pulses at the repetition period in a second direction at a second frequency, the second direction being different from the first direction and the second frequency being different from the first frequency, and
listening to the echoes emitted at the first frequency in the first direction, and
N second recurrences following the M recurrences and comprising a step of:
emitting pulses at the repetition period in the second direction at the second frequency, and
receiving the echoes emitted at the second frequency in the second direction.

2. The method according to claim 1, wherein the method comprises the implementation of P sequences, each sequence being implemented at a respective repetition period.

3. The method according to claim 1, wherein each sequence includes an additional series of:
M additional recurrences following N recurrences and comprising a step of:
emitting pulses at the repetition period in an additional direction at an additional frequency, the additional direction being different from the directions of the previous recurrences and the additional frequency being different from the frequencies of the previous recurrences, and
listening to the echoes emitted at the frequency and direction of the echoes received during the reception step of the N recurrences that the M additional recurrences follow, and
N additional recurrences following the M additional recurrences and comprising a step of:
emitting pulses at the repetition period in the additional direction at the additional frequency, and
receiving the echoes emitted at the additional frequency in the additional direction, the sequence including (K−2) additional series for K directions observed by the radar, K being an integer greater than or equal to 3.

4. The method according to claim 1, wherein, during each emission step, at least one emitted pulse includes a respective random phase introduced by the radar and, wherein each reception step of an echo received from the at least one emitted pulse with a random phase comprises the compensation of the phase shift related to the introduced random phase.

5. The method according to claim 1, wherein the method includes a step of processing the received echoes to determine at least one of a distance of a target and a speed of a target in the environment.

6. The method according to claim 1, wherein the method includes a step of analyzing the echoes listened to during a listening to obtain an electromagnetic behavior in the direction and frequency of the listened echoes.

7. The method according to claim 6, wherein
the method includes a step of processing the received echoes to determine at least one of a distance of a target and a speed of a target in the environment, and
the processing step takes into account the electromagnetic behavior obtained in the analysis step.

8. A radar adapted to perform the implementation of several recurrences of a signal emission and reception step, at least one sequence of recurrences comprising, for N and M two integers:
N first recurrences during which the radar is adapted to:
emit pulses at a repetition period in a first direction at a first frequency, and
receive echoes emitted at the first frequency in the first direction,
M recurrences following the N first recurrences and during which the radar (16) is adapted to:
emit pulses at the repetition period in a second direction at a second frequency, the second direction being different from the first direction and the second frequency being different from the first frequency, and
listen to echoes emitted at the first frequency in the first direction, and
N second recurrences following the M recurrences and during which the radar is adapted to:
emit pulses at a repetition period in the second direction at the second frequency, and
receive echoes emitted at the second frequency in the second direction.

9. An observation system including the radar according to claim 8.

10. An aircraft comprising the radar according to claim 8.

11. An aircraft comprising the observation system according to claim 9.
